(19) United States
(12) Patent Application Publication
(10) Pub. No.: US 2014/0120361 A1
(43) Pub. Date: May 1, 2014

(54) Upright Object Surround

(71) Applicant: Luicen Quentin Junkin, (US)

(72) Inventor: Luicen Quentin Junkin, (US)

(21) Appl. No.: 13/662,591

(22) Filed: Oct. 29, 2012

(51) Int. Cl. G09F 7/20; A47G 33/00; A47G 33/08

(52) U.S. Cl. CPC G09F 7/20; A47G 33/08; A47G 33/00
USPC 428/596; 428/34.2; 428/36.92; 428/35.6

(57) ABSTRACT

A Surround (11) designed to (a) encircle, enclose, obscure, shroud or cloak the base of upright objects like Christmas trees, support columns, and potted plants (FIG. 2) or (b) attach to and encircle a portion of objects like lamp posts, sign posts, and support columns (FIG. 4). The Surround can be comprised of any number of vertical sides with panels (12) connected together with flaps (13) on the top that reduce the size of the top opening. Addition flaps (34) on the bottom of the panels would reduce the size of the bottom opening and facilitate positioning the Surround (32) above ground. The surfaces of Surround panels (33) and flaps are adorned with decoration or information, or left plain for user decoration or information. The Surround includes hinged, bending, or folding connections along with assembly connectors. The Surround is installed by forming and connecting it around an upright object.

### CROSS-REFERENCE TO RELATED APPLICATIONS

This application claims the benefit of provisional patent application No. 61/553,251, filed Oct. 31, 2011 by the present inventors.

### FEDERALLY SPONSORED RESEARCH

None

### SEQUENCE LISTING

Not applicable

### BACKGROUND

The following is a tabulation of some prior art that presently appears relevant:

| Pat. Nr. | Issue Date | Patentee | Title |
|---|---|---|---|
| 2,868,255 | Jan. 13, 1959 | Fancher et al | Combination cover and enclosure for |
| | | | Christmas trees and other displays |
| 3,784,136 | Jan. 8, 1974 | Lopez et al | Christmas tree stand holder |
| 4,581,277 | Apr. 8, 1986 | Neale | Christmas tree stand skirt |
| 4,922,652 | May 8, 1990 | Graves | Shelter for trees |
| 5,256,461 | Oct. 26, 1993 | Johnson | Collapsible flower pot and Christmas tree |
| | | | stand cover |
| 5,593,743 | Jan. 14, 1997 | Baker | Christmas tree skirt support |
| 5,891,535 | Apr. 6, 1999 | Bucuk | Base covering for Christmas tree stand, or |
| | | | other domestic objects |
| 5,911,633 | Jun. 15, 1999 | Sofy et al | Decorative surround for a Christmas tree |
| | | | display stand |
| 6,023,882 | Feb. 15, 2000 | Heinrich | Christmas tree stand cover |
| D115902 | Aug. 1, 1939 | Barton et al | Design for a tree base |
| D188192 | Jun. 14, 1960 | Riveras et al | Christmas tree skirt |
| D334355 | Mar. 30, 1993 | Moody | Fence for ornamental trees |
| D340206 | Oct. 12, 1993 | Bonney | Christmas tree base cover |
| D356522 | Mar. 21, 1995 | Schroeder | Christmas tree village base |
| D389777 | Jan. 27, 1998 | Altieri | Enclosed Christmas tree stand and |
| | | | platform |
| D407040 | Mar. 23, 1999 | Marks | Kit for Christmas tree surround |
| D497831 | Nov. 2, 2004 | Anderson et al | Christmas tree stand wrap |

This article relates to a decorative or utilitarian omni-directional Surround for the base or a portion of an upright object, such as a Christmas tree, plant, architectural element, column, sign post, or light pole. For holiday, special occasions, or decorative use, the Surround would be decorated with seasonal, celebratory, or other themes. For informational applications, the Surround would be adorned with advertising, directions, cautions, and other information. When the surround is placed around the base of columns or upright architectural features it can also be used to restrict proximity to the object. When placed around columns, signs, or light poles, the Surround can be attached at a level that provides the best visual effect or impact. Furthermore, this article relates to collapsible panels, which may be readily attached to surround an upright object.

Traditionally, upright objects such as Christmas trees, plants, architectural elements, columns, sign posts, and light poles present an opportunity for hiding unsightly and untidy bases, providing decorative treatment, or presenting information. This Surround meets that need for a cover that can readily be used to surround the upright object for a period of time and then easily collapsed to a generally flat configuration for storage.

In conclusion, insofar as we are aware, no product formerly developed provides the upright object surround capability with user accessibility to the upright object and collapsibility for storage between uses.

### Advantages

Several advantages of one or more aspects are: relatively inexpensive for one-time uses, very economical with reuse, surfaces can be used flexibly for either decoration or information, user connections that can be released for access to the upright object base, and can be easily disassembled fully to collapse to a generally flat configuration for storage.

### SUMMARY

This article creates a Surround to (a) encircle, enclose, obscure, shroud, or cloak the base or bottom of upright objects such as Christmas trees, telephone poles, lamp posts, sign posts, flag poles, support columns, potted house plants, planted trees, etc., or (b) encircle a portion of upright objects such as telephone poles, lamp posts, sign posts, flag poles, support columns, etc. The exterior surfaces of the Surround are adorned with (1) decoration, (2) information, or (3) space for the user to decorate or convey information.

A Surround is comprised of any number of generally vertical side panels that connected together are either (a) free standing to encircle the bottom of the upright object with an opening for the upright object to protrude, or (b) configured to attach to the upright object at a level determined by the user.

The decorative adornment of Surround side panels will generally be theme oriented, such as seasonal, occasional, contemporary, topical, artistic, or educational. However, the decorative adornment of the side panels may be plain or a simple border so as to provide a surface for user self decoration. When used to convey information, the adornment of the side panels would include notification, warning, educational, commercial, or advertisement messages, or plain or simple borders so as to provide a surface for user written messages.

The Surround can be made from a variety of, or a combination of, materials such as cardboard, foam board, plastic, wood, or metal. The Surround can consist of any number of side panels, where at least one of the side panel connections is connected by the user such that the Surround can be installed by forming and connecting it around the upright object as opposed to slipping the Surround over the upright object or placing the upright object within the Surround.

The Surround embodiment has horizontal or angled flaps connected to the top of the side panels and angled inward so as to further obscure or cloak the base or bottom of the upright object. An embodiment includes flaps on the bottom of the side panels to reduce the size of top and bottom openings and to permit the mounting or attachment of the Surround to the upright object above ground level using features of the upright object or a variety of attachment devices such as straps or clamps.

Adjacent flaps are connected by the user so as to provide (a) additional freestanding stability when used around a vertical object base, or (b) additional connectability when attaching the Surround to the upright object above ground level.

The adjacent side panel and flap connections are hinged such that the Surround can be collapsed to a generally flat configuration for packaging, transportation, and storage. The hinged connections can be of a separate or integrated hinge device, or they may be achieved through the deformation or flexibility of the material connecting the panels.

The user connections of all panels and flaps of the Surround are releasable such that the Surround can be partially disconnected for access to the base or bottom of the upright object or fully disconnected to collapse to a generally flat configuration for storage, including between uses.

### DRAWINGS

### Figures

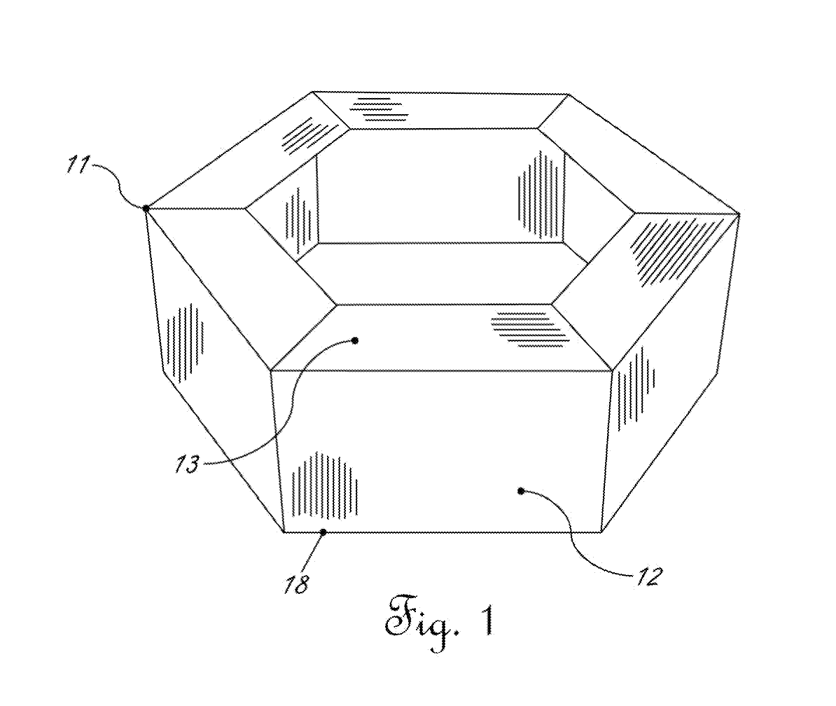

FIG. 1 is a perspective view of a six-sided embodiment of the Surround constructed and assembled in accordance with one embodiment.

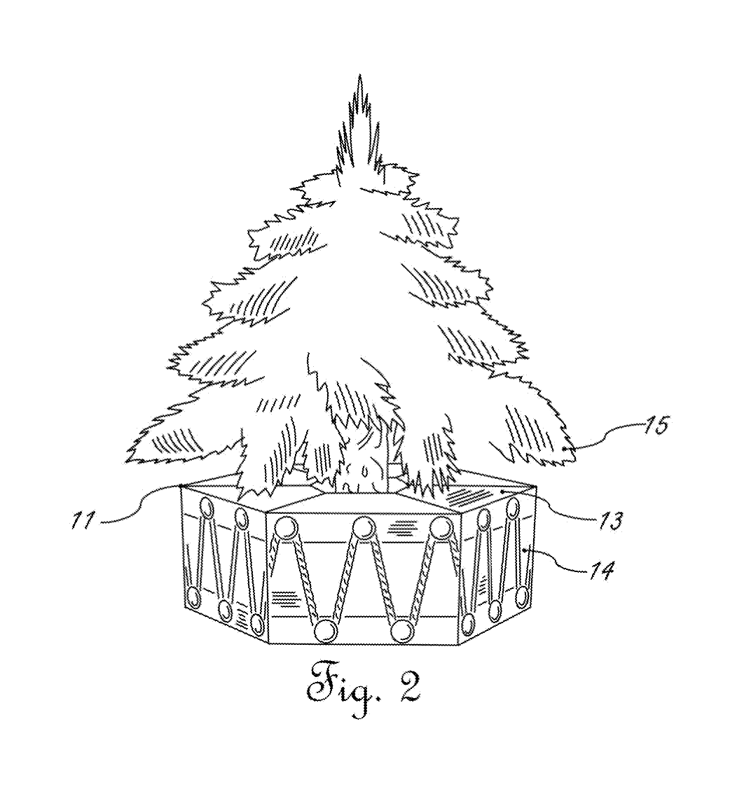

FIG. 2 is a perspective view of the Surround of FIG. 1 assembled as a covering around the base of a Christmas tree.

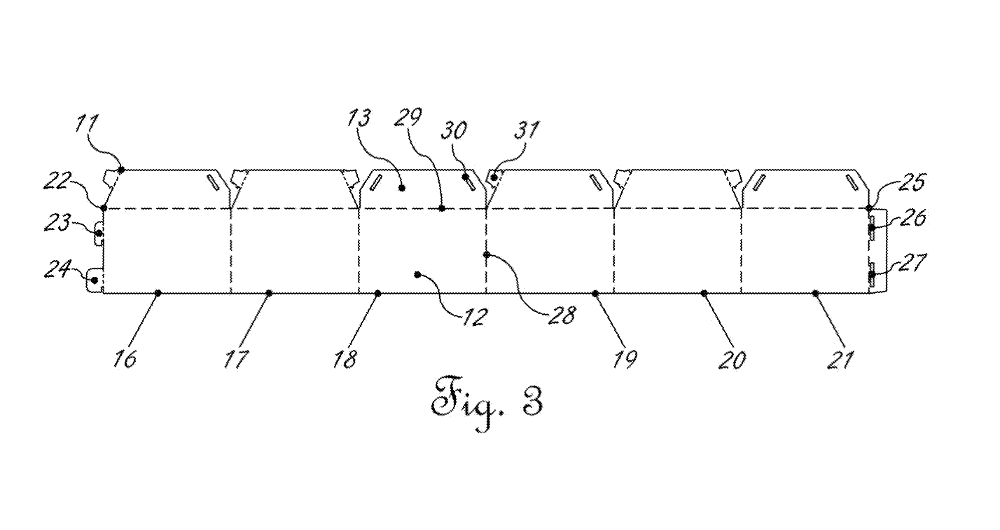

FIG. 3 is a plan view of the flat, unassembled Surround in FIG. 1.

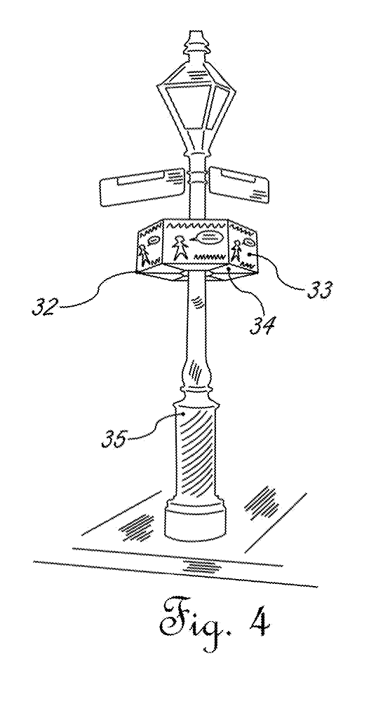

FIG. 4 is a perspective view of an informational six-sided Surround placed part way up a street lamp pole.

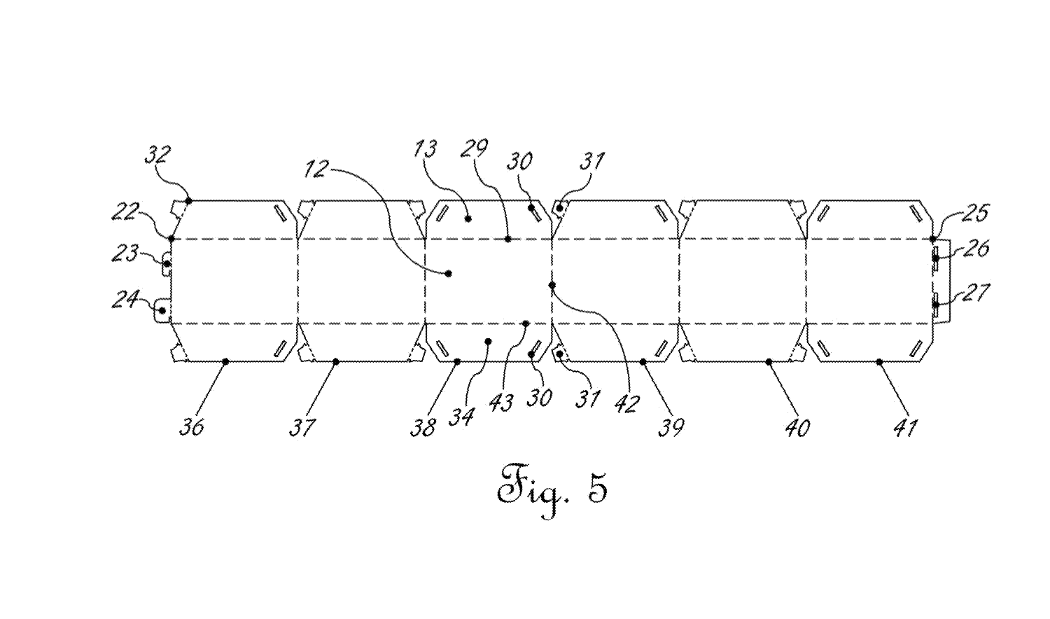

FIG. 5 is a plan view of the flat, unassembled Surround in FIG. 4.

### REFERENCED NUMERALS

11. Surround
12. panel
13. top flap
14. decorated panel
15. Christmas tree
16. side location, which includes panel and top flap
17. side location, which includes panel and top flap
18. side location, which includes panel and top flap
19. side location, which includes panel and top flap
20. side location, which includes panel and top flap
21. side location (includes panel and top flap)
22. end panel with connector tabs
23. panel to panel connector tab
24. panel to panel connector tab
25. end panel with connector slots
26. panel to panel connector slot
27. panel to panel connector slot
28. panel to panel hinge
29. panel to flap hinge
30. flap to flap connector slot
31. flap to flap connector tab
32. Surround
33. information panel
34. bottom flap
35. street light pole
36. side location, which includes panel and top and bottom flaps
37. side location, which includes panel and top and bottom flaps
38. side location, which includes panel and top and bottom flaps
39. side location which includes panel and top and bottom flaps
40. side location, which includes panel and top and bottom flaps
41. side location, which includes panel and top and bottom flaps
42. panel to panel hinge
43. panel to flap hinge

### DETAILED DESCRIPTION

FIG. 1 is a perspective view of a Surround 11 embodying an assembled six-sided version of the article. This typical Surround embodiment consists of panels designed to be assembled in a self supporting six-sided cylindrical configuration around the base of an upright object. Each side 18 consists of a panel 12 with an attached top flap 13 that folds inward to further conceal the base of the upright object while providing additional structural stability and the general appearance of a “top” on the Surround. The flaps are connected by the user to each other and easily disconnected for storage or access to the base of the upright object.

FIG. 2 is a perspective view of a Christmas tree base Surround 11 embodied in FIG. 1. This typical decorative Surround embodiment consists of panels designed to be arranged in a multi-sided cylindrical fashion around the base of a Christmas tree 15 to provide a decorative shroud for the tree stand or holder. Each side has a theme decorated panel 14 with an attached flap 13 that folds inward to further conceal the base and lower tree trunk while providing the general appearance of a “top” on the Surround. The user connected top flaps are easily disconnected to provide access for watering a tree. Decoration of the panels 14 and flaps 13 include Christmas and holiday themes as well as a plain white or neutral shade offering for the user to “self color” or “self decorate.”

FIG. 3 is a plan view of the flat, unassembled six sided embodiment of the Surround 11 in FIGS. 1 and 2. Each of the six side locations 16, 17, 18, 19, 20, and 21 are made up of a repeating series of a panel 12 and a top flap 13. Panels 12 have hinged connections to each other at fold lines 28. The top flap 13 is hinged to panel 12 at fold line 29. End panel 22 with tabs is connected to the end panel 25 with slots, by the user with tabs 23 and 24 and slots 26 and 27. Flaps are connected to each other by a tab 31 and a slot 30.

FIG. 4 is a perspective view of a Surround 32 where each side panel 33 has an associated bottom flap 34 in addition to the top flaps shown on the Surround 11 in FIG. 1. This typical informational Surround embodiment consists of sides designed to be arranged in a cylindrical fashion around the pole portion of a street light 35. The Surround 32 displays information on each panel 33 at an elevation appropriate for the message and target audience as determined by the user.

FIG. 5 is a plan view of the flat, unassembled six sided embodiment of the Surround 32 in FIG. 4. Each of the six side locations 36, 37, 38, 39, 40, and 41 are made up of a repeating series of a panel 12, a top flap 13, and a bottom flap 34. Panels 12 have hinged connections to each other at fold line 42. The top flap 13 is hinged to panel 12 at fold line 29. The bottom flap 34 is hinged to panel 12 at fold at line 43. The end panel 22 with tabs is connected to the end panel 25 with slots, by the user with tabs 23 and 24 and slots 26 and 27. Flaps are connected to each other by a tab 31 and a slot 30.

### Operation

In operation, the Surround 11, with suitable decoration and information on panels, is user installed around an upright object by shaping the Surround at hinged connections, positioning it around the upright object, and fastening it together using integrated fasteners as in FIG. 2. When the Surround 32 is placed above ground as in FIG. 4, the Surround is positioned at the desired level by using a feature on the upright object, such as a ledge, or secured to the upright object using a fastener, such as a strap or clamp.

Examples of typical uses:

A Surround 11 as in FIG. 2 would be placed around a Christmas tree stand where panels are adorned with a nativity scene or winter panorama to create a more festive atmosphere.

A Surround placed around a light pole as in FIG. 4, secured several feet above the ground, with the panels 33 adorned with a picture and description of a lost pet along with contact information to help in recovering the lost pet.

Surrounds would be placed around potted plants and trees in the yard with happy birthday well wishes adorning the side panels in conjunction with celebrating a family member's birthday.

Surrounds would be placed around the light posts in a department store's parking lot and secured several feet above the height of the cars with information about a special sale adorning the panels to assist in marketing products.

A Surround would be placed around a bucket used to contain dripping water with a caution that the floor may be slippery adorning the panels to alert people of a slipping hazard.

Surrounds would be placed around sign posts with construction information adorning the panels to inform drivers and pedestrians.

Surrounds would be placed around poles with direction information adorning the panels to indicate the desired course for cyclists and runners during an event.

Surrounds would be placed around light posts in a parking lot with indications, such as pictures of different animals, adorning the panels so people can more easily remember where they parked.

A Surround would be placed around a plastic container used for storing toys with a decorative children's theme adorning the panels to make a drab container match other decor.

Surrounds would be placed around the columns of a theatre and secured about six feet off the ground with information about an upcoming play adorning the panels to inform patrons of the play.

Surrounds would be placed around traffic sign posts and secured about ten feet off the ground with temporary traffic control signage adorning the panels.

Surrounds would be placed around street sign poles and mail box poles with garage sale information adorning the panels to inform passersby of a garage sale without the need for driving stakes in the ground or fear that the sign would blow away.

What is claimed is:

1. An article comprising:
a plurality of generally vertical side panels that connected together are free standing or can be attached to upright objects to (a) encircle, enclose, obscure, shroud, or cover the base or bottom, of objects such as Christmas trees, telephone poles, lamp posts, sign posts, flag poles, support columns, potted house plants, planted trees, etc. or (b) attach to and encircle an above ground portion of upright objects such as telephone poles, lamp posts, sign posts, flag poles, support columns, etc. and
with flaps attached to the top of the side panels that angle inward to reduce the size of the top openings, and
said panels and flaps are of a single or a combination of stiff materials such as cardboard, foam board, plastic, wood, or metal, and
said panels and flap surfaces are adorned with decoration or information or are left plain for user decoration or information, and
with hinged, bending, or folding connections between said panels and between panels and flaps, and
with user operated connections that provide a means for assembling the article around an existing upright object, and
all user connections are releasable, and can be easily released, and
when removed, the article folds to a generally flat configuration for movement and storage.

2. An assembly as set forth in claim 1 with flaps attached to the bottom of the side panels that are angled inward to reduce the size of the bottom opening and further facilitate attaching the article at a user designated location along the length of the upright object.
